(19) United States
(12) Patent Application Publication
(10) Pub. No.: US 2025/0240537 A1
(43) Pub. Date: Jul. 24, 2025

(54) Method for Providing Color Correction for a Specific Camera Sensor

(71) Applicant: Robert Bosch GmbH, Stuttgart (DE)

(72) Inventor: Andrei-Alexandru Tachici, Cluj-Napoca (RO)

(21) Appl. No.: 19/020,643

(22) Filed: Jan. 14, 2025

(30) Foreign Application Priority Data
Jan. 18, 2024 (EP) 24152679.7

(51) Int. Cl. H04N 23/84; H04N 23/85

(52) U.S. Cl. CPC H04N 23/843; H04N 23/85

(57) ABSTRACT

A method for providing color correction for a specific camera sensor includes (i) providing a reference image, wherein the reference image results from a capture of the specific camera sensor, (ii) performing a color interpolation of the reference image to provide an interpolated image, (iii) determining at least one respective area of interest for the colors red, green and blue in the interpolated image, (iv) forming an average of color values in each determined area of interest to obtain a respective resulting average color, (v) assigning a respective reference color to each resulting average color, wherein the reference colors comprise at least the colors red, green and blue, (vi) generating a color correction matrix based on color values of the reference image, (vii) calculating a respective intermediate variable for the colors red, green and blue based on the generated color correction matrix, and (viii) minimizing a respective difference for the colors red, green and blue between the color values of the reference image and the respective intermediate variable calculated to provide the color correction for the specific camera sensor. Further disclosed are a computer program, a device, and a storage medium for this purpose.

This application claims priority under 35 U.S.C. § 119 to patent application no. EP 24152679.7, filed on Jan. 18, 2024 in Europe, the disclosure of which is incorporated herein by reference in its entirety.

The disclosure relates to a method for providing color correction for a specific camera sensor. The disclosure further relates to a computer program, a device, and a storage medium for this purpose.

### BACKGROUND

A color correction matrix (CCM) is a tool used in digital image processing to correct and adjust the colors in digital images. Its main purpose is to optimize the color reproduction of an image sensor by correcting the color deviations that can occur through the sensor and lens of the recording device.

The color correction matrix comprises a matrix of values that are applied to the color channels of an image to correct the colors. Typically, it includes a 3×3 matrix, wherein each row of the matrix represents the red, green, and blue channels of the image. By multiplying the color values of a pixel by this matrix, color casts can be corrected, color saturation can be adjusted, and the overall color balance can be improved.

In the prior art, for example, weighted sums are used to define the color correction matrix and in practice, furthermore, look-up tables are usually used to reconstruct the image. Also, further information about an existing camera sensor or a specific existing hardware is often needed, which, for example, must be determined on the basis of a measurement of the wavelength of a recorded image parallel to the camera sensor.

For example, document US20090268044A1 describes a method for adjusting the pixel colors of an image. According to any white balance of the raw image data of the digital image, the white-balanced image data is forwarded to a color correction module as color vectors in a color space for color adjustment using a color correction matrix.

Document US20110019913A1 discloses a method for generating a color correction matrix (CCM) for an image sensor. In this method, quantum efficiency (QE) spectra of image sensor pixels illuminated by a physical light source are measured. Subsequently, color values of the image sensor and color values in a predetermined color space are determined according to the QE spectra and predetermined reference data that are essential for deriving the color values. Finally, the color correction matrix for the image sensor is generated by applying a fitting algorithm to the color values of the image sensor and the color values in the predetermined color space.

### SUMMARY

The subject-matter of the disclosure is a method, a computer program, a device, and a computer-readable storage medium having the features set forth below. Further features and details of the disclosure will emerge from the following description and the drawings. Features and details which are described in connection with the method according to the disclosure naturally also apply in connection with the computer program according to the disclosure, the device according to the disclosure, and the computer-readable storage medium according to the disclosure, and vice versa in each case, so that reference is always or can always be made to the individual aspects of the disclosure with respect to the disclosure.

The object of the disclosure is, in particular, a method for providing color correction for a specific camera sensor, comprising the following steps, wherein the steps can be carried out repeatedly and/or sequentially. The camera sensor preferably captures images in a range visible to the human eye. The term “specific” refers to the camera sensor, for example, as a particular type or a particular model.

In a first step, preferably one reference image is provided, wherein the reference image results from a capture of the specific camera sensor. It is also conceivable that at least two reference images are provided. The reference image can be captured using an FPGA-based frame grabber. The data, i.e. in particular the at least one reference image, can be provided in real time at 30 FPS, for example using RAW16 CSI coding, in order to advantageously enable a real-time application of the method according to the disclosure or an application of the provided color correction. Furthermore, in the context of the present disclosure, a Compute Unified Device Architecture (CUDA) based application can utilize an image signal processor (ISP) and image reconstruction (IMR).

In a further step, color interpolation of the reference image is preferably carried out to provide an interpolated image. The color interpolation can also be referred to as demosaicing or debayering. The color interpolation, or demosaicing or debayering, is a process by which a complete color image can be generated from a Bayer pattern of the reference image, which in particular contains only brightness information. In particular, a full-color image is created from raw, color-filtered data. A color can be calculated for each pixel by interpolating information from neighboring pixels. For example, the green and blue values for a red pixel are estimated from the surrounding pixels to obtain a complete RGB color value.

In a further step, at least one respective area of interest is preferably determined for the colors red, green and blue in the interpolated image. Red is in particular a color with a wavelength of about 620-750 nanometers, green with a wavelength of about 495-570 nanometers and blue with a wavelength of about 450-495 nanometers. The determination can be done manually, for example by a user, or also automated, for example on the basis of an object or pattern recognition.

In a further step, an average of color values is preferably formed in each specific area of interest in order to obtain a respective resulting average color. This can be advantageous for compensating for uneven color distributions in the reference image, for example due to shadows or unevenness on surfaces.

In a further step, a respective reference color is preferably assigned to each resulting average color, wherein the reference colors comprise at least the colors red, green and blue. In simplified terms, for example, a resulting average color which essentially corresponds to the color red or is to correspond to it is assigned the reference color red. The same can be done for the colors green and blue.

In a further step, a color correction matrix is preferably generated on the basis of color values of the reference image. The color values of the reference image may be measured color channel values of the reference image. The color correction matrix (CCM) is generated in particular in the form of nine variables, wherein three variables are provided for a respective color, i.e. in particular red, green and blue. The color correction matrix thus preferably comprises a 3×3 matrix, wherein each row of the matrix represents the red, green and blue channel of the image.

In a further step, an intermediate variable is calculated for each of the colors red, green and blue on the basis of the generated color correction matrix, in particular also on the basis of the color values of the reference image. This can be done, for example, using the following equations.

$${R}^{′} = R * CCM [ 0 ] [ 0 ] + G * CCM [ 0 ] [ 1 ] + B * CCM [ 0 ] [ 2 ]$$

$${G}^{′} = G * CCM [ 1 ] [ 0 ] + G * CCM [ 1 ] [ 1 ] + B * CCM [ 1 ] [ 2 ]$$

$${B}^{′} = B * CCM [ 2 ] [ 0 ] + G * CCM [ 2 ] [ 1 ] + B * CCM [ 2 ] [ 2 ]$$

Where R′ G′ B′ are in particular the intermediate variables and R, G, B are measured color channel values of the reference image. R, G and B stand for red, green and blue, respectively.

In a further step, a respective difference for the colors red, green and blue between the color values of the reference image and the respectively calculated intermediate variable is minimized in order to provide the color correction for the specific camera sensor. This is exemplified in the pseudo-code below, wherein the variables R_real, G_real and B_real represent the respective red, green and blue color values of the reference image:
Minimize(abs(R′−R_real))
Minimize(abs(G′−G_real))
Minimize(abs(B′−B_real))

The method according to the present disclosure can advantageously be used to improve image processing and thus, for example, the detection of objects in the images by way of the provided color correction. This can be particularly advantageous in the context of an application in a vehicle, especially in an at least partially automated vehicle. An image to which the provided color correction has been applied can advantageously more strongly exhibit the colors perceived by a human or, in other words, appear visually more natural to a human.

The method may further comprise the following step:
rendering the interpolated image in order to determine (103) the at least one respective area of interest on the basis of the rendered interpolated image.

Rendering the interpolated image can simplify the process of determining the area of interest in the interpolated image, in particular if it is intended that a user will determine these areas manually.

In addition, it is conceivable that the assignment (105) comprises the following step:
creating a table, wherein the table comprises a respective assignment of the reference colors to the resulting average colors.

The table can advantageously provide a database for the further steps of the method, which can be modified depending on the application.

In another example, the generation of the color correction matrix is performed using a non-integer equation solver, wherein three variables are generated for each color. Using a non-integer equation solver can result in faster and more efficient generation of the color correction matrix because fewer iterations may be required.

For example, the non-integer equation solver can be an advanced process optimizer or an interior point optimizer.

Advanced Process Optimizer (APOPT) is, in particular, an optimization algorithm that can be used to solve mixed-integer nonlinear programming (MINLP) problems. The way APOPT works can be summarized as follows: APOPT is suitable, for example, for problems that include both continuous and discrete decision variables. APOPT uses, in particular, a branch and bound algorithm. This is, in particular, a method for solving optimization problems with integrality conditions. The algorithm works by systematically dividing the solution space into smaller sub-areas (branches) and examining these individually. By setting upper limits (bounds) for the optimal value, unpromising areas of the solution space can be excluded to speed up the search. For the continuous variables of the problem, APOPT preferably uses nonlinear programming methods to find optimal or near-optimal solutions. This includes, for example, the application of techniques such as gradient methods or interior point methods. For the discrete variables, APOPT particularly takes into account integrality constraints to ensure that the final solution meets the requirements of the problem. For example, the algorithm tests various combinations of integer values and evaluates their effect on the overall optimum. One issue in using APOPT is the distinction between global and local optima. APOPT seeks to find the global optimum but may also provide local optima depending on the complexity of the problem and the specific parameter settings.

Interior point optimizer (IPOPT) is a numerical optimization algorithm for solving large-scale nonlinear programming (NLP) problems. IPOPT is particularly specialized for solving nonlinear programming problems. These problems include, for example, an objective function that is to be minimized or maximized while adhering to nonlinear equations and inequalities as constraints. IPOPT uses the interior point approach by preference. This approach differs, for example, from boundary point methods (such as simplex for linear problems) in that it remains inside the feasible domain during the solution process instead of navigating along the boundaries. This often enables a more efficient traversal of the solution space. In particular, the core of IPOPT is an iterative strategy. In each iteration step, an approximate solution can be generated based on the current estimate of the optimum. This approximate solution can then be used to calculate the next estimate. To determine the direction and size of the next steps, IPOPT preferably solves nonlinear systems of equations. This can be done using techniques such as the Newton method and linear programming. The algorithm preferably iterates until a solution is found that is within a predetermined tolerance range. This means that the changes between successive iterations are particularly small enough to conclude that the solution is close to the optimum.

It is also possible that the non-integer equation solver is configured to perform a breadth-first search in a nonlinear programming mode. Nonlinear programming refers in particular to the solution of problems in which at least one objective function and/or at least one constraint is a nonlinear function. Breadth-first search refers in particular to a special way of searching the solution space, for example, for optimization problems that involve discrete decisions (such as integer variables). In particular, breadth-first search is a strategy in which all branches at one level of the decision tree are examined before moving on to the next levels. This is in contrast to the depth-first strategy, for example, in which a branch of the tree is explored as deeply as possible before moving on to other branches.

In another example, the method furthermore comprises the following step:
determining the color values of the reference image based on an analysis of the reference image.

This can be done, for example, by pixel-by-pixel analysis, histogram analysis or automated color detection, for example using machine learning.

It is possible that the method according to the disclosure is used in a vehicle, in particular for a specific camera sensor of at least one camera of the vehicle. The vehicle can be designed, for example, as a motor vehicle and/or passenger vehicle and/or at least partially automated vehicle. The vehicle may comprise a vehicle device, e.g., for providing an autonomous driving function and/or a driver assistance system. The vehicle device may be configured to control and/or accelerate and/or brake and/or steer the vehicle, at least partially automatically.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a device, a storage medium and a computer program according to exemplary embodiments of the disclosure.

### DETAILED DESCRIPTION

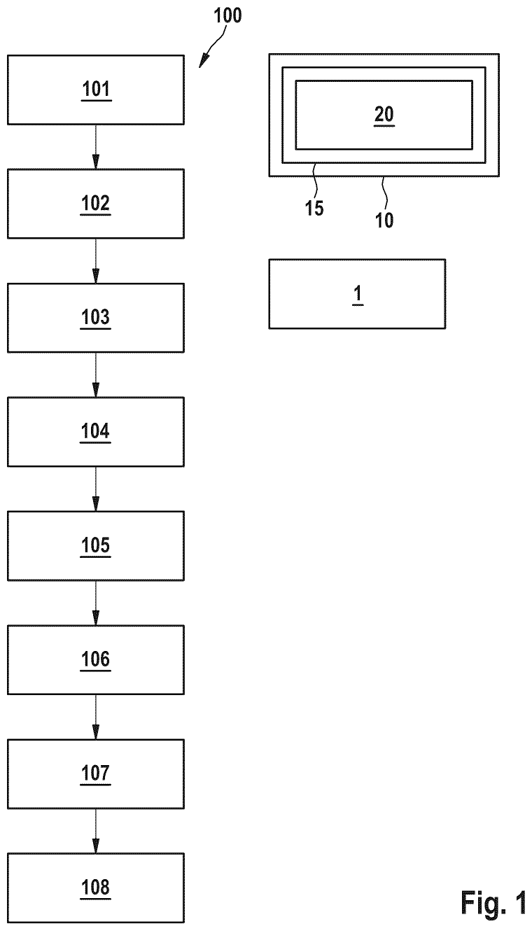

FIG. 1 schematically illustrates a method 100, a camera sensor 1, a device 10, a storage medium 15 and a computer program 20 according to exemplary embodiments of the disclosure.

FIG. 1 shows in particular an exemplary embodiment of a method 100 for providing color correction for a specific camera sensor 1. In a first step 101, a reference image is provided, wherein the reference image results from a detection of the specific camera sensor 1. In a second step 102, a color interpolation of the reference image is carried out in order to provide an interpolated image. In a third step 103, at least one respective area of interest for the colors red, green and blue is determined in the interpolated image. In a fourth step (104), an average of color values in each determined area of interest is formed in order to obtain a respective resulting average color. In a fifth step (105), a respective reference color is assigned to each resulting average color, wherein the reference colors comprise at least the colors red, green and blue. In a sixth step 106, a color correction matrix is generated on the basis of color values of the reference image. In a seventh step 107, an intermediate variable is calculated for the colors red, green and blue on the basis of the generated color correction matrix. In an eighth step 108, a respective difference for the colors red, green and blue between the color values of the reference image and the respectively calculated intermediate variable is minimized in order to provide the color correction for the specific camera sensor 1.

According to any debayering step in the image signal processor, an image may still include raw values for the RGB diodes. These values represent the response of photodiodes to a particular wavelength and are particularly not suitable to be interpreted as correct colors when rendering the image.

Therefore, according to the exemplary embodiments of the disclosure, the following system of equations with 9 variables is solved. The color correction matrix (CCM) can advantageously combine the output of each color in the raw RGB image, since each photodiode reacts more or less to the entire visible spectrum.

$${R}^{′} = R * CCM [ 0 ] [ 0 ] + G * CCM [ 0 ] [ 1 ] + B * CCM [ 0 ] [ 2 ]$$

$${G}^{′} = G * CCM [ 1 ] [ 0 ] + G * CCM [ 1 ] [ 1 ] + B * CCM [ 1 ] [ 2 ]$$

$${B}^{′} = B * CCM [ 2 ] [ 0 ] + G * CCM [ 2 ] [ 1 ] + B * CCM [ 2 ] [ 2 ]$$

When executed correctly, the output image, i.e. an image to which the color correction provided in accordance with the exemplary embodiments of the disclosure has been applied, can advantageously resemble the colors perceived by a human being.

The reference image can be captured using an FPGA-based frame grabber. The data, i.e. in particular the at least one reference image, can be provided in real time at 30 FPS, for example using RAW16 CSI coding. Furthermore, an application based on a Compute Unified Device Architecture (CUDA) can apply the image signal processor (ISP) and image reconstruction (IMR). The image reconstruction can take place immediately after the debayering step. This makes it easier to determine or select the areas of interest (ROIs) in the reference image, especially in the case of a manual selection, for example by a user.

According to an exemplary embodiment of the disclosure, the following steps can be carried out to obtain and apply the color correction matrix. steps can be carried out to obtain and apply the color correction matrix. In a first step, a reference image can be provided, which can result from a capture of the specific camera sensor 1. In a second step, a de-baying and/or interpolation step (“debayering step”) can be applied to the acquired reference image. In a third step, an output of the previous step can be rendered so that the captured reference image can be visualized. In a fourth step, at least one area of interest (ROI) can be selected for each color of the captured reference image. In a fifth step, an area can be averaged in each area of interest and a resulting average color can be determined for the respective area of interest. In a sixth step, a table can be created with a measured color, i.e. the resulting average color of an area of interest, and a corresponding reference color. Each area of interest can thus be assigned a corresponding reference color. In a seventh step, nine variables of a color correction matrix can be generated using an advanced process optimizer (APOPT) or an interior point optimizer (IPOPT) solver configured to perform a breadth-first search branching in a nonlinear programming (NLP) mode. For each color, three intermediate variables may further be introduced into the solver. The use of intermediate variables can make a beneficial contribution to convergence here. The equations resulting from the seventh step above are shown below:

$${R}^{′} = R * CCM [ 0 ] [ 0 ] + G * CCM [ 0 ] [ 1 ] + B * CCM [ 0 ] [ 2 ]$$

$${G}^{′} = G * CCM [ 1 ] [ 0 ] + G * CCM [ 1 ] [ 1 ] + B * CCM [ 1 ] [ 2 ]$$

$${B}^{′} = B * CCM [ 2 ] [ 0 ] + G * CCM [ 2 ] [ 1 ] + B * CCM [ 2 ] [ 2 ]$$

Where R′ G′ B′ are intermediate variables in the solver and R, G, B are measured color channel values. R, G, B stand for red, green and blue, respectively.

In an eighth step, lenses can be used instead of equations. Three lenses can be specified for each reference color. The objective is to minimize an absolute value of a difference between the measured color channel and the adjusted color channel, i.e. in particular the determined intermediate variable. This is exemplified in the following pseudo-code:
Minimize(abs(R′−R_real))
Minimize(abs(G′−G_real))
Minimize(abs(B′−B_real))

In a ninth step, the solver can be executed and an output can be visualized.

The above explanation of the embodiments describes the present disclosure solely within the scope of examples. Of course, individual features of the embodiments may be freely combined with one another, if technically feasible, without leaving the scope of the present disclosure.

What is claimed is:

1. A method for providing color correction for a specific camera sensor, comprising:
providing a reference image, wherein the reference image results from a capture of the specific camera sensor;
performing a color interpolation of the reference image to provide an interpolated image;
determining at least one respective area of interest for the colors red, green and blue in the interpolated image;
forming an average of color values in each determined area of interest to obtain a respective resulting average color;
assigning a respective reference color to each resulting average color, wherein the reference colors comprise at least the colors red, green and blue;
generating a color correction matrix based on color values of the reference image;
calculating a respective intermediate variable for the colors red, green and blue based on the generated color correction matrix; and
minimizing a respective difference for the colors red, green and blue between the color values of the reference image and the respective intermediate variable calculated to provide the color correction for the specific camera sensor.

2. The method according to claim 1, further comprising:
rendering the interpolated image in order to determine the at least one respective area of interest on the basis of the rendered interpolated image.

3. The method according to claim 1, wherein the assigning step comprises:
creating a table, wherein the table comprises a respective assignment of the reference colors to the resulting average colors.

4. The method according to claim 1, wherein:
the generating step is performed using a non-integer equation solver, and three variables are generated for each color.

5. The method according to claim 4, wherein the non-integer equation solver is an advanced process optimizer or an interior point optimizer.

6. The method according to claim 4, wherein the non-integer equation solver is configured to perform a breadth-first search in a nonlinear programming mode.

7. The method according to claim 1, further comprising:
determining the color values of the reference image based on an analysis of the reference image.

8. A computer program comprising commands for causing the computer to carry out the method according to claim 1 when the computer program is executed by a computer.

9. A device for data processing, configured to carry out the method according to claim 1.

10. A computer-readable storage medium, comprising commands which, when executed by a computer, cause the computer to carry out the steps of the method according to claim 1.
